(19) United States
(12) Patent Application Publication
(10) Pub. No.: US 2014/0260604 A1
(43) Pub. Date: Sep. 18, 2014

(54) MOISTURE METER

(71) Applicant: Amphenol Corporation, (unknown)

(72) Inventor: Christopher James Elliott Ranwell, Andover, MA (US)

(73) Assignee: Amphenol Corporation

(21) Appl. No.: 13/834,138

(22) Filed: Mar. 15, 2013

(51) Int. Cl. G01N 27/04; G01N 19/10

(52) U.S. Cl. CPC G01N 27/048; G01N 19/10
USPC 73/335.01; 324/696; 73/335.02

(57) ABSTRACT

A moisture meter detects one or more conditions within an environment. The moisture meter includes a housing and one or more detection pins structurally supported by the housing. The detection pins being can measure moisture. The moisture meter further includes a sensing probe structurally supported by the housing. The sensing, probe being can measure humidity within the environment. Operation of one of the one or more detection pins and the sensing probe does not interfere with operation of the other of the one or more detection pins and the sensing probe. A method of detecting one or more conditions with a moisture meter

### BACKGROUND OF THE INVENTION

1. Field of the Invention

The present invention relates generally to a moisture meter and, in particular, to a moisture meter structurally supporting one or more condition sensing structures.

2. Discussion of the Prior Art

Moisture meters are known and used to detect a condition within an environment. This condition may include, for example, temperature, humidity, moisture content, or the like.

In the past, moisture meters often required one or more separate, auxiliary sensing devices. For instance, in one example, the moisture meter may require an auxiliary, separately attachable pin-type moisture detecting device for detecting moisture. The same moisture meter may also require an auxiliary, separately attachable humidity probe. These separate attachments were often in the form of a cable or wire with a plug/output disposed at one end and the moisture detecting device or humidity probe attached at an opposing end. Separate attachments were likewise needed for measuring temperature, surface temperature, or the like. It is somewhat cumbersome and unwieldy to carry these separate attachments with the moisture meter and time consuming to change attachments. Further, these separate attachments are relatively expensive and can be easily lost, misplaced, or damaged. Accordingly, there is a need and it would be beneficial for a moisture meter to integrally support a plurality of condition sensing devices without the need for separate attachments.

### BRIEF DESCRIPTION OF THE INVENTION

The following presents a simplified summary of the invention in order to provide a basic understanding of some example aspects of the invention. This summary is not an extensive overview of the invention. Moreover, this summary is not intended to identify critical elements of the invention nor delineate the scope of the invention. The sole purpose of the summary is to present some concepts of the invention in simplified form as a prelude to the more detailed description that is presented later.

In accordance with one aspect, the present invention provides a moisture meter for detecting one or more conditions within an environment. The moisture meter includes a housing and one or more detection pins structurally supported by the housing. The detection pins can measure moisture. A sensing probe is structurally supported by the housing. The sensing probe can measure humidity within the environment.

In accordance with another aspect, the present invention provides a moisture meter for detecting one or more conditions within an environment. The moisture meter includes a housing and one or more detection pins structurally supported by the housing. The one or more detection pins can measure moisture. A sensing probe is structurally supported by the housing. The sensing probe can measure humidity within the environment. Operation of one of the one or more detection pins and the sensing probe does not interfere with operation of the other of the one or more detection pins and the sensing probe.

In accordance with another aspect, the present invention provides a method of detecting one or more conditions at substantially the same time with a moisture meter. The method includes the step of providing housing. The method further includes the step of structurally supporting one or more detection pins with the housing, the detection pins measuring moisture. The method further includes the step of structurally supporting a sensing probe with the housing, the sensing probe measuring humidity. Operation of the detection pins or the sensing probe does not interfere with operation of the other of the detection pins or the sensing probe.

### BRIEF DESCRIPTION OF THE DRAWINGS

The foregoing and other aspects of the present invention will become apparent to those skilled in the art to which the present invention relates upon reading the following description with reference to the accompanying drawings, in which:

FIG. 1 is a perspective view of an example moisture meter in accordance with an aspect of the present invention, with a part shown in a detached state:

FIG. 2 is a plan view of the moisture meter structurally supporting detection pins and an infrared detector, with the one part removed from view;

FIG. 3 is a rear elevation view of the moisture meter structurally supporting a sensing probe and a surface detector, with the one part shown in the detached state:

FIG. 4 is a block diagram of the moisture meter including an example processor and plurality of sensors:

FIG. 5 is a side view of one example operation of the moisture meter detecting a moisture content of a surface with the surface detector; and

FIG. 6 is a perspective view of a second example operation of the moisture meter detecting moisture content with the detection pins exposed via detachment of the one part.

### DETAILED DESCRIPTION OF THE INVENTION

Example embodiments that incorporate one or more aspects of the present invention are described and illustrated in the drawings. These illustrated examples are not intended to be a limitation on the present invention. For example, one or more aspects of the present invention can be utilized in other embodiments and even other types of devices. Moreover, certain terminology is used herein for convenience only and is not to be taken as a limitation on the present invention. Still fluffier, in the drawings, the same reference numerals are employed for designating the same elements.

FIG. 1 depicts an example embodiment of a moisture meter 10 in accordance with one aspect of the invention. It is to be appreciated that FIG. 1 merely shows one example of the possible structure/configuration of the moisture meter 10, and that other examples are contemplated within the scope of the present invention. In general, the moisture meter 10 is used for monitoring one or more conditions within an environment. The conditions may include, for example, humidity, temperature surface temperature, dew point, moisture content measurements, etc. The moisture meter 10 may be used in any number of environments, including residential locations (e.g., houses, basements, attics, etc.), commercial locations, indoor or outdoor locations, or the like.

The moisture meter 10 includes a housing 12. The housing 12 may have a level of ergonomic design such that the housing 12 can be easily handheld. The housing 12 can include any number of materials, including plastics, metals, or the like. The housing 12 can include a relatively sturdy/durable material so that the housing 12 is at least somewhat impervious to damage from drops, inadvertently applied forces, high/low temperatures or humidity levels, presence of liquids, etc.

In the shown example, the housing 12 includes a handle portion 14. The handle portion 14 is sized and shaped so as to be easily grasped by a human hand. In the shown example, the handle portion 14 is elongated and substantially linearly extending with rounded/arcuate corners and edges. The handle portion 14 is not limited to the shown shape, and in other examples, could include any variety of shapes.

The handle portion 14 of the housing 12 can further include a keypad 16. The keypad 16 includes one or more control/function buttons that allow a user to control and/or input information to the moisture meter 10. In the one shown example, the keypad 16 includes four direction buttons that are disposed in proximity to where the user's thumb would be when gripping the handle portion 14. The direction buttons would allow navigation operation by the user. The shown example keypad includes other buttons (e.g., power, enter, etc.) Of course, the keypad 16 is not limited to the shown configuration, and could take on any number of configurations and structures. Indeed, the keypad 16 could include more or fewer buttons than as shown, and in other examples, could include a trigger switch, joystick, or the like. Likewise, the keypad 16 is not limited to being positioned at the shown location, and in other examples, could be positioned along sides of the housing 12, etc.

The housing 12 further includes a display 20. Within the shown example, the display 20 is located adjacent and above the handle portion 14 and keypad 16. The display 20 includes a screen, monitor, or other similar image displaying apparatus. The display 20 can include associated video controllers, drivers, etc. to provide imagery upon the display 20. The display 20 can display images in black and white, or in color, and can take on a number of sizes and shapes. Indeed, the display 20 could be larger or smaller in size, and could take on other shapes (i.e., not limited to the quathilateral shape of FIG. 1). The display 20 can display images, video, text, or the like that may be related to the conditions within the environment.

The housing 12 further includes one or more input ports. In the shown example, the housing 12 includes a first input 22 and a second input 24. The first input 22 and second input 24 allow for one or more auxiliary, supplementary, secondary, etc. devices to be removably attached to the housing 12. In the shown example, the first input 22 and second input 24 each include a female socket for receiving a plug, connector, or other similar device. The first input 22 and second input 24 are not limited to the female socket shown in FIG. 1, and in other examples, could include any type of connecting ports, such as a universal serial bus (USB) port, mini/micro USB port, etc. Further, the housing 12 is not specifically limited to including two inputs (e.g., first input 22 and second input 24), but instead could include as few as one input, or more than two inputs. Likewise, the inputs need not be identical, but, rather, could each include a different type of input (e.g., female socket. USB, mini/micro USB, etc.). Further, while the first input 22 and second input 24 are shown to be positioned along, a side of the housing 12, this placement is not intended to be limiting, as the first input 22 and second input 24 could be positioned nearly anywhere along the housing 12.

The moisture meter 10 further includes a cover 26. The cover 26 is shown in a detached state from the housing 12, as it is to be understood that the cover 26 is selectively removable from/attachable to the housing 12. During operation, the cover 26 can either be attached to or detached from the housing 12. The cover 26 is positioned at an end of the housing 12 opposite the handle portion 14. The cover 26 has a size and shape that at least somewhat matches the size and shape of a surrounding portion of the housing 12. As such, the cover 26 will be generally flush with respect to the housing 12 when the cover 26 is attached. The cover 26 can, in one example, include an identical material as the material forming the housing 12. As such, the cover 26 will provide at least some degree of protection (e.g. durability, resiliency, etc.) to the portion of the moisture meter 10 that is located within the cover 26.

The cover 26 and/or the housing 12 may include means for securing the cover 26 to the housing 12, such as locking means, snap fit means, mechanical fasteners, or the like. Also, the moisture meter 10 may further include structure/means (not shown) to connect or tether the cover 26 to the housing 12 when the cover is detached (unsecured) from the housing. Such connecting/tethering structure/means may include a short length of cord, flexible polymer material, a hinge or the like. In an example, the cover 26 can support one or more batteries, such as replacement batteries, for the moisture meter 10. Similarly, the cover 26 can also support a connector to facilitate recharging of the batteries.

Turning now to the means for detecting the conditions within the environment, the housing 12 structurally supports one or more detection pins 30. The detection pins 30, shown as a pair of detection pins, are integrally and structurally supported by the housing 12 such that the detection pins 30 are directly attached to the housing 12. As such, auxiliary, supplementary, or secondary wires, cables, or other attachment means are not needed to attach the detection pins 30 to the housing 12. The detection pins 30 extend outwardly from a surface of the housing 12. In this example, the detection pins 30 are disposed at an end of the housing 12 opposite the handle portion 14. The detection pins 30 can be selectively covered/uncovered by the cover 26 so as to reduce the risk of inadvertent damage to the detection pins 30 and/or injury to a user. In one example, the cover 26 can be selectively removed during use of the detection pins 30, and replaced when use of the detection pins 30 is no longer needed.

The detection pins 30 function as part of an arrangement for measuring moisture within the environment. The detection pins 30 can be placed in contact with a surface, such as a wall, floor, ceiling, etc. The surface can include any type of material, such as wood, tile, or the like. In other examples, the detection pins 30 can be at least partially pushed into the surface. For example, due to the pin-like size/shape, the detection pins 30 can be embedded at least partially into a wood surface to measure moisture content within the wood material (i.e., below the surface).

As is generally known, current can flow through and out one of the detection pins 30, into the material (e.g., wood, tile, etc.), and into the other of the detection pins 30. Based on the moisture content of the material, the resistance to the current between the detection pins 30 will change. For instance, in one example, a relatively dry material, such as wood, will allow relatively little current to pass between the detection pins 30. Conversely, a material (e.g., wood) that has a higher moisture content has a lower resistance to the current passing between the detection pins 30. Accordingly, the moisture meter 10 can analyze the resistance of the material and accurately correlate this resistance to the moisture content of the material. The moisture content can then be shown on the display 20.

Referring now to FIG. 2, a top view of the moisture meter 10 is shown with the cover 26 removed. The moisture meter 10 is shown without the cover 26 for illustrative purposes so as to more clearly depict the top portion of the housing 12. As set forth above, however, the cover 26 can be selectively replaced so as to shield the top portion of the moisture meter 10.

In this example, the moisture meter 10 further includes an infrared detector 40. The infrared detector 40 is a non-contact, optically based temperature sensing apparatus that can measure a temperature, including a surface temperature, within the environment. The infrared detector 40 includes a number of structures commonly associated with infrared sensing, including a lens, an infrared temperature sensor, etc. The infrared detector 40 is structurally supported at the top portion of the housing 12 such that the infrared detector 40 can be aimed or directed towards a desired location within the environment. For instance, a user can grip the handle portion 14 and move the moisture meter 10 so as to point the infrared detector 40 at the desired location. Of course, the infrared detector 40 is not limited to being positioned at the top portion of the housing 12, and in other examples, could be positioned on a side surface, front or back surface, etc.

The infrared detector 40 detects temperature by measuring infrared emissions that are emitted by an object or a surface. In one example, the infrared detector 40 can receive infrared light emitted from the object or surface onto an infrared sensor or detector located within the moisture meter 10. The sensor/detector can absorb the infrared radiation and convert this infrared radiation into a current. The current correlates to a temperature of the object or surface. As such, the infrared detector 40 can detect a surface temperature within the environment while the moisture meter 10 is located a distance away from the object's surface. This temperature measurement made by the infrared detector 40 is beneficial in measuring surface temperatures of difficult to reach objects/locations (e.g., ceilings, obstructed locations, etc.).

It is to be appreciated that with the shown example, the infrared detector 40 is located upon the moisture meter 10 at a position that can be selectively covered and uncovered by the cover 26, similar to the detection pins 30. With the cover 26 secured to the housing 12, the cover 26 can provide some level of protection concerning the infrared detector 40. For example, the cover 26 can help prevent dirt and debris from contacting the infrared detector 40. As another example, the cover 26 can provide a shielding effect for the infrared detector 40 against impacts.

The moisture meter 10 can further include an aiming beam to assist in aiming the infrared detector 40 towards the object. In the present example, the aiming beam includes a laser. The laser can shine through an aperture 42 that is structurally supported by the housing 12 adjacent the infrared detector 40. It is to be appreciated, however, that the aiming beam is not limited to the shown laser and aperture 42, and could include other visual aiming devices. The aperture 42 for the laser is positioned in relatively close proximity to the infrared detector 40 at the top portion of the moisture meter 10. Of course, the aperture 42 is not limited to this location, and instead could be positioned at nearly any location within the housing 12 that is in close proximity to the infrared detector 40. In operation, the aperture 42 can emit a beam of light that is generally parallel to an axis along which the infrared detector 40 receives infrared light emitted from the object. Again, the cover 26 can provide selectively covering and uncovering and thus can provide some level of protection concerning the laser and associated aperture 42.

Turning now to FIG. 3, a rear portion of the moisture meter 10 is shown. The rear portion of the moisture meter 10 is located opposite the front portion, which is shown in FIG. 1 and includes the keypad 16, display 20, etc. The rear portion of the moisture meter 10 includes a sensing probe 50. The sensing probe 50 is structurally supported by the housing 12. In the shown example, the sensing probe 50 is supported within a recess 52 formed in the housing 12. Of course, the sensing probe 50 is not limited to this location, and could be positioned at other locations on the housing 12. By being structurally supported by the housing 12, the sensing probe 50 does not require auxiliary, supplementary, or secondary wires, cables, or other attachment means. Rather, the sensing probe 50 can be attached directly to the housing 12.

The sensing probe 50 can detect relative humidity and/or ambient temperature within the environment. In one example, the sensing probe 50 will detect both relative humidity and ambient temperature. In one possible example, the sensing probe 50 can detect relative humidity within a range of approximately 30 to 100% and ambient temperature within a range of approximately 0° to 50° Celsius. In yet another example, the sensing probe 50 can detect relative humidity within a range of approximately 1 to 100% and ambient temperature within a range of approximately −10° to 70° Celsius. Of course, other ranges are envisioned, as the sensing probe 50 is not specifically limited to the ranges disclosed herein.

Due to its size and location, the sensing probe 50 will not interfere with the operation of the detection pins 30. Rather, the sensing probe 50 extends a shorter distance in length than the detection pins 30, such that the detection pins 30 extend a farther distance away from the housing 12 than the sensing probe 50. Note that within the shown example the sensing probe 50 is at a location that is down and relatively recessed with respect to the detection pins 30. In one example, the sensing probe 50 is selectively extendable during its operation. As such, the sensing probe 50 can be extended by a user while still remaining attached to the housing 12. Extending the sensing probe 50 can allow for more accurate measurement of humidity and/or temperature. The sensing probe 50 can be retracted to the position shown in FIG. 3 when not in use, so as to not block or obstruct the detection pins 30. As such, the detection pins 30 can be operated, such as by being placed in contact with a surface, without the sensing probe 50 interfering, blocking, or otherwise obstructing the detection pins 30 from contacting the surface. Likewise, the sensing probe 50 can be operated without interference or obstruction from the detection pins 30.

As shown in FIG. 3, the detection pins 30 can be supported by a surface that generally extends along a plane 51 (illustrated generically/schematically with dashed lines). The infrared detector 40 is likewise supported by the surface that extends along the plane 51. In the illustrated example, the detection pins 30 and the infrared detector 40 can be located on a first side of the plane 51 (e.g., above the plane 51 in the example of FIG. 3). The sensing probe 50 can be located entirely on a second opposing side of the plane 51 (e.g., below the plane 51 in the example of FIG. 3). As such, operation of the detection pins 30 will not interfere with operation of the sensing probe 50, while operation of the sensing probe 50 will not interfere with operation of the detection pins 30.

In further examples, the sensing probe 50 is selectively removable from the housing 12. For instance, the sensing probe 50 can be removed and replaced with a different type of probe. One possible reason for removing and replacing the sensing probe 50 is based on humidity or temperature ranges. In particular, one sensing probe 50 may operate better within a certain humidity/temperature range and/or may operate better for measuring humidity of solid walls and/or floors (i.e, by being inserted into an opening in a concrete floor). On the other hand, a different sensing probe 50 may operate better within a different humidity/temperature range and/or may operate better for measuring open air humidity. Of course, the sensing probe 50 could be selectively removed and/or replaced with any number of probes for a variety of reasons.

The moisture meter 10 further includes a surface detector 56 located at the rear portion of the housing 12. The surface detector 56 is structurally supported by the housing 12. The surface detector 56 defines a substantially flat surface extending along the rear portion of the housing 12. It is to be appreciated that the surface detector 56 is not limited to being located at the rear portion of the housing 12, and in other examples, could be positioned along sides, front, top, etc. of the housing 12.

The surface detector 56 measures moisture content at or slightly below a surface within the environment. In contrast with the detection pins 30, the surface detector 56 can non-invasively measure moisture content without piercing, penetrating or otherwise extending into a surface. To measure moisture content, the surface detector 56 is placed into contact with the surface. The surface detector 56 (e.g., a sensor, transmitter, or the like housed underneath the surface of the housing 12) will then emit one or more electrical waves that create an electromagnetic field. This electromagnetic field is emitted to a predetermined depth into the surface, such as, in one example, approximately 2.54 centimeters (1 inch). The electromagnetic field is affected by the presence or absence of moisture in the material being tested. For instance, the surface detector 56 can measure changes in one or more characteristics of returned emissions from the material and use this measurement to calculate moisture content.

Turning now to FIG. 4, a highly schematic representation of the moisture meter 10 is shown. It is to be appreciated that the moisture meter 10 is generically/schematically depicted in FIG. 4 for ease of illustrating structure/components that may not normally be visible. Indeed, the structure/components depicted in FIG. 4 may be located within the housing 12 of the moisture meter 10. As such, in operation, these structure/components are not visible. It is also to be appreciated that FIG. 4 depicts only some of the unseen structure/components, but that the moisture meter 10 includes further components (e.g., wires, electrical components, connectors, etc.) not shown in FIG. 4.

The moisture meter 10 includes a processor 60. The processor 60 is generically/schematically depicted in FIG. 4, as the processor 60 includes any number of configurations. In general, the processor 60 is capable of sending/receiving information (e.g., data, control instructions, etc.) to other components within the moisture meter 10. The processor 60 can include a controller, microcontroller, printed circuit board, logic units, control units, memory, etc. In this example, the processor 60 can be operatively connected to the display 20. As such, the processor 60 can send information (i.e., information related to the detected conditions within the environment) to the display 20 for providing imagery upon the display 20.

The moisture meter 10 further includes a power supply 62. The power supply 62 is operatively connected to the processor 60. The power supply 62 can include any number of devices that supply electric power to components of the moisture meter 10. The power supply 62 can include, for example, energy storage devices (e.g., batteries, filet cells, etc.), AC or DC power supplies, solar power, or the like. While the power supply 62 is shown to be connected to the processor 60 in FIG. 4, the power supply 62 is not so limited. In other examples, the power supply 62 can be connected to, and thus supply power to, any of the components in the moisture meter 10, including the display 20, sensors, lights (e.g. LED lights, laser, or the like), etc.

The moisture meter 10 further includes one or more peripheral devices operatively connected to the processor 60. These peripheral devices include, in one example, one or more sensors. In the shown example, the one or more sensors include a humidity sensor 64. The humidity sensor 64 is operatively connected to the processor 60. Further, the humidity sensor 64 can be operatively connected to and/or housed within the sensing probe 50. In such an example, the humidity sensor 64 will receive information (e.g., electrical signals or the like) that is indicative of and/or related to the humidity within the environment. Based on this information, the humidity sensor 64 measures the humidity within the environment. This humidity measurement can, in one example, be displayed on the display 20.

The one or more sensors of the moisture meter 10 further include a temperature sensor 66. The temperature sensor 66 is operatively connected to the processor 60. Further, the temperature sensor 66 can be operatively connected to and/or housed within the sensing probe 50 or a temperature probe (not shown). In this example, the temperature sensor 66 will receive information (e.g., electrical signals or the like) that is indicative of and/or related to the temperature within the environment. Based on this information, the temperature sensor 66 measures the temperature within the environment. This temperature measurement can, in one example, be displayed on the display 20.

The one or more sensors of the moisture meter 10 further include an infrared temperature sensor 68 (shown as IR temperature sensor in FIG. 4). The infrared temperature sensor 68 is operatively connected to the processor 60. Further, the infrared temperature sensor 68 can be operatively connected to the infrared detector 40. In this example, the infrared temperature sensor 68 will receive information that is indicative of and/or related to a surface temperature within the environment. This information can include, for example, infrared light emitted from the object or surface. In response to receive this infrared light, the infrared temperature sensor 68 can then produce an electrical current that is indicative of the object's surface temperature within the environment. This surface temperature measurement can, in one example, be displayed on the display 20.

The sensors of the moisture meter 10 further include at least one moisture sensor. In this example, the at least one moisture sensor includes a pin moisture sensor 70. The pin moisture sensor 70 is operatively connected to the processor 60. Further, the pin moisture sensor 70 can be operatively connected to the detection pins 30. The pin moisture sensor 70 will receive information that is indicative of and/or related to the moisture content detected by the detection pins 30. For instance, the pin moisture sensor 70 can measure the resistance to current between the detection pins 30. This resistance to current can then be correlated to the moisture content in the material (e.g. wood, etc.). This moisture content measurement can, in one example, be displayed on the display 20.

The at least one moisture sensor of the moisture meter 10 further includes a surface moisture sensor 72. The surface moisture sensor 72 is operatively connected to the processor 60. Further, the surface moisture sensor 72 can be operatively connected to the surface detector 56. The surface moisture sensor 72 will receive information that is indicative of and/or related to the moisture content detected by the surface detector 56. For instance, the surface moisture sensor 72 can receive information related to the capacity of the material (e.g., wood, etc.) to store energy, the power absorbed by the material from the electromagnetic field, and/or the resistance of the material to the electromagnetic field. This information can be correlated to a moisture content of the material. This moisture content measurement can, in one example, be displayed on the display 20.

Turning now to FIG. 5, an example operation of the moisture meter 10 will now be described. As shown, the moisture meter 10 can be used to measure moisture content of a material having a surface 80. The surface 80 can include, for example, a surface of a wall, floor, ceiling, cabinet, door, etc. Further, the surface 80 includes any number of materials, including wood, drywall, fiberboard tile, etc. While the surface 80 is shown to be substantially flat in this example, the surface 80 is not so limited, and could include bends, curves, undulations, angles, etc.

The moisture meter 10 can be gripped by a user's hand 82. In particular, the user can grip the handle portion 14 to move/manipulate the moisture meter 10. In the shown example, the moisture meter 10 is used to detect moisture content of the surface 80 and surface material with the surface detector 56. To use the surface detector 56, the user can move the moisture meter 10 into close proximity or contact with the surface 80. Next, by pressing one or more of the buttons on the keypad 16, the user will initiate operation of the surface detector 56. One or more electrical waves are emitted into the surface 80, which can create an electromagnetic field. This electromagnetic field will extend into the material past the surface 80. The electromagnetic field is affected by the presence or absence of moisture. Information related to the electromagnetic field is then transferred to the surface moisture sensor 72, Whereupon the moisture content of the material is determined. This moisture content can then be displayed on the display 20 for the User.

Turning now to FIG. 6, another example of the operation of the moisture meter 10 is shown. In this example, the moisture meter 10 can be used to measure moisture content of the material having the surface 80. The handle portion 14 of the moisture meter 10 can again be gripped by the user's hand 82. In this example, the moisture meter 10 is being used to detect moisture content with the detection pins 30. To use the detection pins 30, the user can move the moisture meter 10 into contact with the surface 80. In one example, the detection pins 30 can penetrate at least partially into the surface 80. Next, by pressing one or more of the buttons on the keypad 16, the user will initiate operation of the detection pins 30.

Current will flow from one of the detection pins 30, through the surface 80, and into the other of the detection pins 30. A resistance to the current between the detection pins 30 changes based on the material's moisture content. This resistance is detected and measured by the pin moisture sensor 70, whereby the resistance is correlated to the moisture content of the material.

As shown in FIG. 6, the detection pins 30 can be freely used to determine moisture content without obstruction, blockage, or other interference by the sensing probe 50 (obstructed from view in FIG. 6). Likewise, the detection pins 30 are structurally supported by the housing 12 in such a way that the detection pins 30 will not obstruct/block, or interfere with the operation of the sensing probe 50. Accordingly, the user can use/operate either or both of the detection pins 30 and the sensing probe 50 without obstruction or blockages.

As shown in the example, information related to the moisture content can be displayed on the display 20 for viewing by the user. In this example, the display 20 includes a moisture content indication 90 (e.g., in percentage). The moisture content indication 90 in this example is numerical. The display 20 is not limited to showing numerical information. Instead, the display 20 may include a scale indication 92 that plots the degree of wetness of the material. Further, the display 20 may include a text indication 94 related to the wetness of the material. As shown, the text indication 94 indicates that the material is wet. Of course, the text indication 94 could also display “dry” if the material is dry or the like.

It is to be appreciated that the display 20 is not limited to showing the information of FIG. 6. Rather, other information could also simultaneously be displayed, including temperature, humidity, surface temperature, proximity to dew point, etc. In one possible example, the processor 60 can analyze the surface temperature and the humidity to calculate a surface proximity to dew point. This surface proximity to dew point can likewise be shown on the display 20.

It should be noted that various example modes of operation permit a great amount of single hand operation. Of course, use of two hands (e.g., operation of the key pad via a second hand) is possible. The integration and positioning as part of the structural supporting, in accordance with aspects of the present invention, provide for improvements concerning single hand operation. As such, the operator may achieve greater efficiency, comfort, or the like.

The invention has been described with reference to the example embodiments described above. Modifications and alterations will occur to others upon a reading and understanding of this specification. Example embodiments incorporating one or more aspects of the invention are intended to include all such modifications and alterations insofar as they conic within the scope of the appended claims.

What is claimed is:

1. A moisture meter for detecting one or more conditions within an environment, the moisture meter including:
a housing;
one or more detection pins structurally supported by the housing, the detection pins being configured to measure moisture; and
a sensing probe structurally supported by the housing, the sensing probe being configured to measure humidity within the environment.

2. The moisture meter of claim 1, wherein the one or more detection pins includes a pair of detection pins for measuring moisture, further wherein the sensing probe is configured to measure temperature and humidity within the environment.

3. The moisture meter of claim 2, further including a surface detector structurally supported by the housing, the surface detector including a surface moisture sensor for non-invasively measuring moisture.

4. The moisture meter of claim 3, wherein the surface detector is positioned at a separate location on the housing; than the pair of detection pins, the surface detector defining a substantially flat surface for measuring moisture.

5. The moisture meter of claim 3, further including an infrared detector structurally supported by the housing, the infrared detector being configured to measure surface temperature.

6. The moisture meter of claim 5, further including a laser structurally supported by the housing adjacent the infrared detector.

7. The moisture meter of claim 6, further including a processor that is configured to analyze the surface temperature and the humidity to calculate a surface proximity to dew point.

8. The moisture meter of claim 1, wherein the sensing probe is selectively removable from the housing.

9. The moisture meter of claim 1, further including a display structurally supported by the housing, the display being configured to display information related to the one or more conditions detected within the environment.

10. The moisture meter of claim 1, wherein the detection pins are supported on a surface of the housing, the detection pins being located on a first side of a plane, the sensing probe being located entirely on a second opposing side of the plane.

11. A moisture meter for detecting one or more conditions within an environment, the moisture meter including:
a housing;
one or more detection pins structurally supported by the housing, the one or more detection pins being configured to measure moisture; and
a sensing probe structurally supported by the housing, the sensing probe being Configured to measure humidity within the environment, wherein operation of one of the one or more detection pins and the sensing probe does not interfere with operation of the other of the one or more detection pins and the sensing probe.

12. The moisture meter of claim 11, wherein the one or more detection pins includes a pair of detection pins for measuring moisture, further wherein the sensing probe is configured to measure temperature and humidity within the environment.

13. The moisture meter of claim 12, further including a surface detector structurally supported by the housing, the surface detector including a surface moisture sensor for non-invasively measuring moisture.

14. The moisture meter of claim 13, wherein the surface detector is positioned at a separate location on the housing than the pair of detection pins, the surface detector defining a substantially flat surface for measuring moisture.

15. The moisture meter of claim 13, further including an infrared detector structurally supported by the housing, the infrared detector being configured to measure surface temperature.

16. The moisture meter of claim 15, further including a laser structurally supported by the housing adjacent the infrared detector.

17. A method of detecting one or more conditions at substantially the same time with a moisture meter, the method including the steps of:
providing a housing;
structurally supporting one or more detection pins with the housing, the detection pins configured to detect moisture; and
structurally supporting; a sensing probe with the housing, the sensing probe configured to detect humidity, wherein operation of the detection pins or the sensing probe does not interfere with operation of the other of the detection pins or the sensing probe.

18. The method of claim 17, wherein the one or more detection pins includes a pair of detection pins structurally supported at an end of the housing.

19. The method of claim 18, wherein the pair of detection pins are structurally supported adjacent an infrared detector, the infrared detector being structurally supported at the end of the housing.

20. The method of claim 17, wherein the sensing probe is selectively removable from the housing.
